(19) United States
(12) Patent Application Publication
(10) Pub. No.: US 2012/0135364 A1
(43) Pub. Date: May 31, 2012

(54) ORTHODONTIC BRACKET WITH AUXILIARY SLOT

(75) Inventors: Lee Tuneberg, Sheboygan, WI (US); Jaume Mesalles, Kohler, WI (US)

(73) Assignee: American Orthodontics, Inc., a Wisconsin Corporation, Sheboygan, WI (US)

(21) Appl. No.: 13/302,621

(22) Filed: Nov. 22, 2011

Related U.S. Application Data
(60) Provisional application No. 61/416,140, filed on Nov. 22, 2010.

(51) Int. Cl. A61C 7/30; A61C 7/28

(52) U.S. Cl. 433/9

(57) ABSTRACT

An orthodontic bracket includes a slot for attaching auxiliary attachments. The slot is formed into the pad of the bracket rather than being included in the bracket body. By forming the slot into the pad of the bracket rather than incorporating it into the bracket body, the slot may have a vertical orientation and may be centered on the bracket.

### CROSS-REFERENCE TO RELATED APPLICATION

This application is based on and claims priority to U.S. Provisional Patent Application No. 61/416,140 filed on Nov. 22, 2010, which is incorporated herein by reference in its entirety for all purposes.

### FIELD OF THE INVENTION

The present invention relates generally to the field of brackets for use in orthodontia. More particularly, the present invention relates to orthodontic brackets having an auxiliary slot for the attachment of auxiliary devices.

### BACKGROUND

In the field of orthodontics, there is a need to apply a variety of different forces to teeth in a multitude of ways. One component that orthodontists use to provide such forces are brackets (or braces) in conjunction with an arch wire. Brackets may be made of various metal alloys, ceramics, or other materials, and are commonly manufactured in multiple parts. Specifically, a bracket body and a pad are bonded together to create a bracket. The pad provides a surface configured for attaching to the tooth, and the bracket body provides a pathway for the arch wire to pass through. The pad and bracket body are bonded together in the manufacturing process, usually by welding or brazing, but other bonding techniques may be used as well. One bracket is attached to each tooth using adhesive material. The arch wire is generally a thin metal wire that runs from bracket to bracket and applies pressure to the teeth, over time causing them to change position and/or orientation.

Orthodontic brackets are typically machined, molded, or cast, requiring precision tooling that is expensive to produce and difficult to modify once created. As a result, it is often not possible or prohibitively expensive to add provisions for an auxiliary slot to an existing bracket mold. Adding such an auxiliary slot would require completely new tooling, at great expense to the manufacturer.

Orthodontic brackets typically fall into one of two categories: conventional and self-ligating. Conventional brackets utilize elastomeric ligatures to secure an archwire to the brackets. Self-ligating brackets utilize permanently installed clips or other mechanical closures to entrap the archwire in the brackets.

During the course of treatment, it is sometimes necessary to exert force on teeth in a direction other than the direction of the arch wire. When this is the case, an auxiliary device may be attached to one or more brackets, allowing the orthodontist additional control over how force is exerted on the teeth.

Such auxiliary devices are typically attached to the brackets through the use of a slot incorporated into the bracket. Incorporating the auxiliary slot into each bracket presents a number or shortcomings. Ideally, auxiliary slots would be in a vertical orientation relative to a horizontal archwire, but because of the configuration of both conventional and self-ligating orthodontic brackets, auxiliary slots often must be in a horizontal configuration because there is not enough material in the vertical direction to support a vertically oriented slot. Additionally, such a vertical slot would ideally be located equidistant from the mesial and distal edges of the bracket to facilitate efficient force application to the tooth. In certain traditional brackets there is space to include a vertical slot in the ideal location, but in self-ligating brackets, the enclosure mechanism occupies that space. Thus, in existing self-ligating brackets that include a vertical slot, the slot is offset to one side of the bracket body where there is adequate material to create a slot and the slot does not interfere with the closure mechanism.

### SUMMARY

The present invention relates to an orthodontic bracket with an auxiliary slot. The bracket includes a pad that is contoured to engage a tooth surface. The bracket further includes a body that extends from the pad including an archwire slot. The body may include a closure mechanism to entrap an archwire in the archwire slot. Alternatively, the body may include tie-wings that allow an orthodontist to apply elastomeric ligatures to entrap an archwire in the archwire slot. An auxiliary slot is formed into the pad and is configured to accept auxiliary attachments.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of an orthodontic bracket in accordance with the invention.

FIG. 2 is another perspective view of the orthodontic bracket of FIG. 1 showing the self-ligating clip removed from the bracket.

FIG. 3 is a top view of the orthodontic bracket of FIG. 1.

FIG. 4 is a bottom view of the orthodontic bracket of FIG. 1.

FIG. 5 is a side view of the orthodontic bracket of FIG. 1.

FIG. 6 is a front view of the orthodontic bracket of FIG. 1.

FIGS. 7A-D are front views of pads constructed in accordance with alternative embodiments of the present invention.

### DETAILED DESCRIPTION

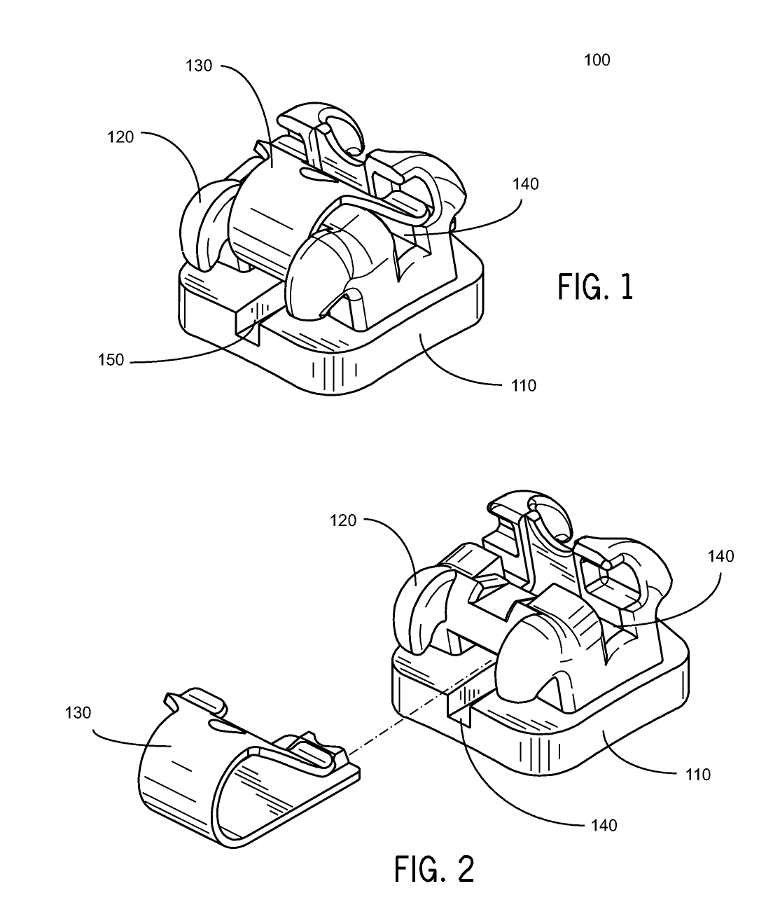

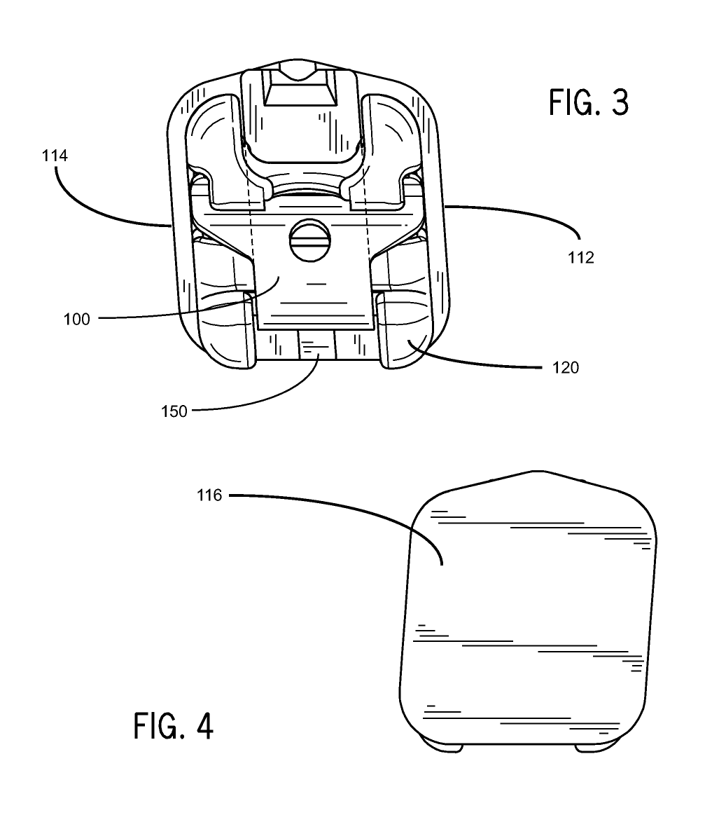

Referring to FIGS. 1-6, one embodiment of an orthodontic bracket 100 in accordance with the invention is shown. The bracket 100 is made by bonding a pad 110 to a bracket body 120. The bonding may be accomplished by welding, brazing, or other suitable method. The pad includes a mesial edge 112 and distal edge 114. In the embodiment shown, the mesial edge 112 and the distal edge 114 are parallel to each other, but the invention contemplates pad edges that are not parallel to each other. Depending on the tooth to which the bracket 100 is to be bonded, the shape of the pad 110 may differ in order to better match the surface profile of the tooth to which the bracket is bonded. Further, the bottom of the pad 116 is contoured to engage the tooth surface. The bottom of the pad 116 may also include a mesh and/or photo etching (not shown) to increase surface area, thereby ensuring a secure bond between the bracket and the tooth.

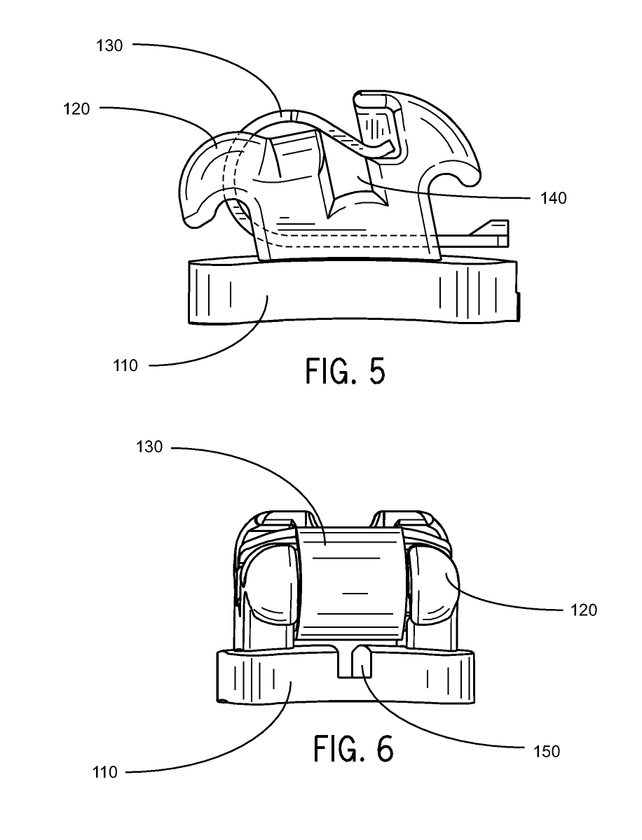

In the embodiment shown, the bracket further includes a clip 130 that can be shifted between an open position and a closed position; when in the closed position, the clip covers an archwire slot 140 as shown in FIGS. 1 and 5. When the bracket 100 is in use, an archwire (not shown) passes through the archwire slot 140 and is entrapped by the clip 130. In an alternative embodiment, the archwire may be entrapped by an elastomeric ligature (not shown). An auxiliary slot 150 is formed into the pad 110. The slot shown in the embodiment of FIGS. 1-6 is generally at least rectangular in cross-section, but may be other shapes as well. In the embodiment shown, the auxiliary slot 150 is generally parallel to the mesial and distal edges 112, 114. Further, the side walls of the auxiliary slot 150 are generally parallel to each other. By moving the auxiliary slot 150 from its typical position in the bracket body 120 to the pad 140, the slot may be formed in an orientation and location that would be otherwise impossible. Such variations may be achieved without departing from the invention. For example, the slot may be offset to either the mesial or distal side of the bracket in order to provide a non-centralized force on the tooth. The slot may also be oriented non-parallel to the mesial/distal edges of the pad.

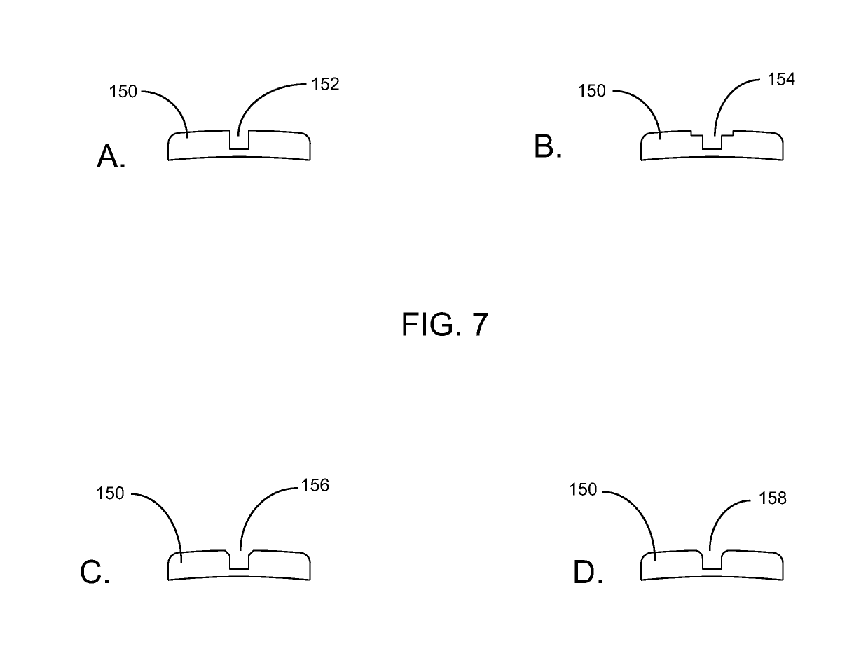

Referring now to FIG. 7A-D, alternative embodiments of the pad 110 are shown. The auxiliary slot 150 may have a number of different cross-sectional profiles. As shown, those profiles may include a rectangular slot 152 with side walls higher than the width of the slot, as shown in FIG. 7A, or a T-slot 154 as shown in FIG. 7B, or the top edges of the slot may be chamfered 156 as shown in FIG. 7C, or the top edges of the slot may include a radius 158, as shown in FIG. 7D. The auxiliary slot 150 may be made with other profiles not shown without departing from the invention.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An orthodontic bracket comprising:
a pad contoured to engage a tooth surface, the pad including a mesial edge and a distal edge;
a bracket body extending from the pad away from the tooth surface, the bracket body including an archwire slot;
the bracket body further adapted to accept a closure mechanism adapted to entrap an archwire within the archwire slot;
an auxiliary slot formed into the pad, the auxiliary slot configured to accept auxiliary attachments.

2. The orthodontic bracket of claim 1 wherein the auxiliary slot is generally parallel to the mesial and distal edges of the pad.

3. The orthodontic bracket of claim 1 wherein the auxiliary slot is non-parallel to the mesial and distal edges of the pad.

4. The orthodontic bracket of claim 1 wherein the auxiliary slot has a rectangular cross-section.

5. The orthodontic bracket of claim 1 wherein the auxiliary slot has a non-rectangular cross-section.

6. The orthodontic bracket of claim 1 wherein the closure mechanism is a spring clip.

7. The orthodontic bracket of claim 1 wherein the closure mechanism is an elastomeric ligature.

8. The orthodontic bracket of claim 1 wherein the auxiliary slot is generally perpendicular to the archwire slot.

9. A self-ligating orthodontic bracket comprising:
a pad adapted to engage a tooth surface;
a bracket body extending from the pad away from the tooth surface, the bracket body including an archwire slot;
a closure mechanism adapted to entrap an archwire within the archwire slot;
an auxiliary slot formed into the pad, the auxiliary slot configured to accept auxiliary attachments.

10. The orthodontic bracket of claim 9 wherein the pad includes at least a mesial edge and a distal edge, and wherein the auxiliary slot is generally parallel to the mesial and distal edges of the pad.

11. The orthodontic bracket of claim 9 wherein the pad includes at least a mesial edge and a distal edge, and wherein the auxiliary slot is non-parallel to the mesial and distal edges of the pad.

12. The orthodontic bracket of claim 9 wherein the auxiliary slot has a rectangular cross-section.

13. The orthodontic bracket of claim 9 wherein the auxiliary slot has two side walls that are substantially parallel to each other.

14. The orthodontic bracket of claim 9 wherein the auxiliary slot has a non-rectangular cross-section.

15. The orthodontic bracket of claim 9 wherein the closure mechanism is a spring clip.
